(19) United States
(12) Patent Application Publication
(10) Pub. No.: US 2009/0179339 A1
(43) Pub. Date: Jul. 16, 2009

(54) Lens molding gasket

(76) Inventors: Youval Katzman, Zichron Yaakov (IL); Zohar Katzman, Haifa (IL)

Correspondence Address: Pearl Cohen Zedek Latzer, LLP, 1500 Broadway, 12th Floor, New York, NY, 10036, US

(21) Appl. No.: 11/919,513

(22) PCT Filed: Apr. 26, 2006
(86) PCT No.: PCT/IL2006/000508

§ 371 Date: Dec. 17, 2008

(30) Foreign Application Priority Data
Apr. 28, 2005 (IL) 168291

(51) Int. Cl. B28B 7/06; B29D 11/00

(52) U.S. Cl. 264/1.32; 249/180

(57) ABSTRACT

A lens molding gasket comprising one integral membrane serving as a mold shell, and a seating for a removable mold shell.

### FIELD OF THE INVENTION

This invention relates to optical plastic lens molding (casting) gaskets and to a method for molding lenses using same.

### BACKGROUND OF THE INVENTION

There are two basic types of spectacle lens materials. Glass is the traditional lens material—it has excellent optical properties, is reasonably scratch-resistant and is inexpensive. However, glass has two disadvantages—it is heavier than plastic and polycarbonate, and it breaks easily, this makes it unsuitable for anyone who is exposed to potential impacts, or for playing sports and poses a hazard for children.

The most common lens materials are hard resins, collectively referred to as ‘plastics’, including polycarbonate which is highly impact resistant making it the material of choice for safety glasses and for sporting applications. Plastic lenses are lighter than glass lenses and are considerably more impact resistant but are usually slightly thicker, and are more prone to scratching unless they have a scratch-resistant coating. There is little difference in the cost of plastic and glass lenses with the same prescription.

Plastic optical lenses are usually molded in a mold comprising a gasket holding two mold shells, typically made of glass and fitted within the gasket at a spaced apart position thus giving rise to a molding cavity formed between the mold shells, wherein at least one of the facing faces of the molding shells form a negative image of the required surfaces of the lens.

Hereinafter in the specification and claims, the term mold shell is used to denote a removable mold shell made of a substantially rigid material suited for sealingly fitting in the gasket for imparting the lens blank (a finished or a semi-finished lens) a negative image of the required surface.

It is common practice that an inside surface of the front mold shell i.e. that facing the rear mold shell, is a negative image of the required front surfaces of the finished lens, though it is not necessarily the case and according to other embodiments, it may be the rear face or both the front face and the rear face which are molded into a final shape.

After completing the molding process and curing of the plastic material, at least one face of the molded work-piece is machined to obtain the required optical parameters of the lens, as well as peripheral portions thereof, so as to fit the shape of a spectacle's frame. Such lenses (i.e. where further machining is required after molding) are referred to in the art as ‘semi-finished-lenses’. The term finished lens denotes a lens blank wherein both faces are formed with final surfacing as far as their corrective power and surface quality, though where the contour of the lens is still to be machined.

A large variety of molding gaskets are known and they share a generally cylindrical shape fitted at their inner face with grooves and/or rims for supporting the two molding shells. According to some embodiments, different arrangements are provided for introducing the liquid form resin into the mold (at an upright or laying position thereof). Also are known different clamping arrangements for retaining the two molding shells at their respective position so as to fix the molding cavity formed between the molding shells.

After molding, the gasket is stripped from the molding shells and is often recycled and molded again into a new gasket. This operation is normally performed manually, with a great deal of lost time. In some instances, prior art lens gaskets have included a tab on the gasket used to identify the particular gasket and to facilitate the stripping of the gasket from the two die halves (the molding shells). For that purpose, there have been suggested some automatic lens mold gasket strippers which eliminate many of the problems associated with the manual removing of gaskets from lens molds.

The molded work-piece is then separated from the molding shells, which in itself is a time consuming process as the work-piece adheres to the inside surfaces of the molding shells. Thus, it is required to apply some force for separating the molded work-piece, often resulting in a chipped molded work-piece and/or chipped molding shells, which are substantially expensive components in the molding process. After separation, the molding shells are thoroughly cleaned and prepared for using again (though at times the molding shells are re-used without cleaning).

It is a primary object of the present invention to provide a lens molding gasket wherein assembly and stripping of the gasket is substantially easier, simpler and shorter than lens molding molds of the aforementioned type. Thus, the present invention suggests a lens molding gasket wherein one of a front mold shell and a rear mold shell is replaced by a membrane shell structure integral with the gasket.

### SUMMARY OF THE INVENTION

According to the present invention there is provided a lens molding gasket comprising one integral membrane serving as a mold shell.

The invention thus calls for a lens molding gasket for molding a finished or a semi-finished-lens comprising a first face and a second face, wherein the gasket comprises a seating for supporting a rigid mold shell having a negative image of said first face of the lens and a membrane integral with the gasket for forming the second surface of the lens, wherein the membrane imparts a negative image of the second surface of the lens blank.

Thus, the improved gasket according to the present invention gives rise to a mold where leaks between the gasket and the mold shell is substantially reduced i.e. limited to one mold shell only, and further reduces required storage space of mold shells by half, handling resources (assembling the mold shell into the gasket, stripping the gasket therefrom, cleaning the mold shell, etc.).

The gasket, according to an embodiment of the present invention, is fitted with an inwardly projecting radial rim (peripheral or segmented) serving to sealingly support a removable mold shell at a fixed axially spaced apart relation. However, according to a different embodiment, the gasket has a smooth inside surface wherein the removable mold shell is held in position owing to pressure applied by the gasket. To increase gripping of the mold shell within the gasket, the inside surface may taper inwardly.

Further embodiments and modifications of the gasket according to the invention may be any one or more of the following:
The membrane is rigidified or reinforced to retain its shape e.g. by thickening of portions thereof, support ribs integral with the gasket, a support member (e.g. made of glass, plastics or metal) fixable behind the membrane, etc.;
The membrane may be flat or assume a pre-shaped configuration e.g. concave or convex;
The gasket may be formed as a single mold for producing one blank lens, or as a double mold for simultaneously producing two blank lenses, oriented back-to-back or otherwise, and wherein the membrane serves as a mold for both lenses. In this case, the membrane may be flat or assume a pre-shaped configuration e.g. concave or convex, or have a different configuration on each face thereof.
The resin may be introduced into the mold via one or more filling ports formed in the gasket. According to one particular arrangement, the filling port optionally serves also as stripping aid member, used for deforming the gasket;
One or more tabs may be provided at different locations of the gasket (e.g. peripheral portions of the gasket) for assisting in striping the gasket, for hanging it within a curing oven, for assisting during manipulation thereof at automated procedures, etc.;
The gasket is not necessarily cylindrical and could be for example oval or otherwise shaped so as to fit the shape of a spectacles lens, or other optical apparatus;
The membrane my have a negative image of the required inside surfaces of the lens blank, or it may be substantially flat and elastically deformable into the required shape by a form member, e.g. a supporting backing made for example of glass; or a support mechanism, e.g. liquid or gas pouch bearing against the diaphragm, etc. This enables manufacturing of standard gaskets where the surface of the second face is dictated by shape of the form member;
The mold may be a disposable one or recyclable for more then one use;
An airing port is formed at the gasket so as to allow air to escape from the cavity upon molding the molten resin.

According to another aspect of the invention there is provided a mold for molding a finished or a semi-finished-lens comprising a first face and a second face, the mold comprising a gasket formed with a seating for supporting a rigid mold shell having a negative image of said first face of the lens, and a membrane integral with the gasket for forming the second surface of the lens, with a cavity formed between said mold shell and said membrane.

According to still another aspect of the present invention there is provided a lens molding gasket fitted with a mold shell support arrangement for loosely retaining the mold shell over the gasket at a position prior to its insertion into its final position to create a molding cavity.

The support arrangement comprises a plurality of projections or a circumferential continues rib from at or adjacent an edge of the gasket, the inside diameter of said projections being slightly less then that of the mold shell.

According to one particular design, the support arrangement comprises a plurality of radially extending ribs. According to a different embodiment, the support arrangement comprises a continues or an interrupted rim. The arrangement is such that the mold shell may be loosely placed over the support arrangement and then forcefully displaced and positioned into the mold by deforming the support arrangement.

### BRIEF DESCRIPTION OF THE DRAWINGS

In order to understand the invention and to see how it may be carried out in practice, several embodiments will now be described, by way of non-limiting examples only, with reference to the accompanying drawings, in which:

FIG. 1 is an isometric, exploded view of a mold comprising a gasket according to an embodiment of the present invention;

FIG. 2A is a vertical cross-section of the gasket seen in FIG. 1;

FIG. 2B is a vertical cross-section through an assembled mold according to FIG. 1;

FIG. 3A is an isometric view of a gasket according to an embodiment of the present invention;

FIG. 3B is a vertical cross-section of the gasket seen in FIG. 3A;

FIG. 4 is a vertical cross-section of a gasket being a modification of the seen in FIG. 3A;

FIG. 5A is an isometric, exploded view of a gasket according to a modification of the present invention;

FIG. 5B is a vertical cross-section of the gasket seen in FIG. 5A;

FIG. 6 is a vertical cross-section through an assembled mold comprising a gasket according to another embodiment of the present invention;

FIG. 7A is a vertical cross-section through an assembled mold comprising a gasket according to still another embodiment of the present invention; and

FIG. 7B is a rear elevation of the gasket seen in FIG. 7A FIG. 8A is a rear perspective view of a gasket according to a modification of the present invention;

FIG. 8B is an isometric sectioned view of the gasket seen in FIG. 8A

FIG. 9A is a vertical cross-section of a gasket according to another embodiment of the invention; and

FIG. 9B is an enlargement of the portion marked IX in FIG. 9A.

### DETAILED DESCRIPTION OF THE INVENTION

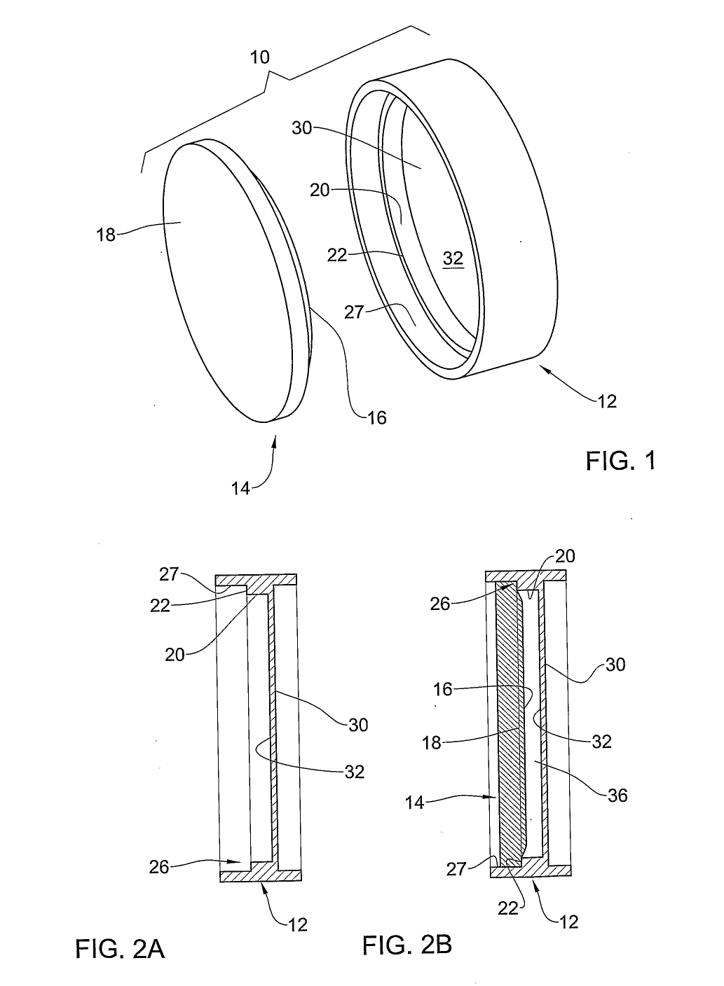

Attention is first directed to FIG. 1 of the drawings illustrating a lens manufacturing molding in accordance with the present invention generally designated 10 comprising a gasket in accordance with the present invention generally designated 12 and mold shell 14 made of rigid material, e.g. glass, and having an inside face 16 and an outside face 18, said inside face having a negative image of a first face of a lens to be molded in the mold 10.

The gasket 12 is typically made of an elastic, thermoplastic material such as PVC, EVA, Milastomere, polyethylene or other suitable elastic materials which are known to be inert to the material to be molded therein and are typically also required to be heat resistant materials, though this depends on the curing method of the molded resin.

The mold shell 14 has a generally circular contour fitted for sealingly bearing against the shoulders 22 of the annular rim 20. Face 16 (the inside face) of the mold shell 14 is concave, whilst the other face 18 may be flat or concave too.

In accordance with the particular embodiment of this Figure, the lens molded in the mold 10 is a so-called semi-finished-lens comprising a first face imparted by the first face 16 of the mold shell 14, typically manufactured at high standards, i.e. substantially without any defects.

Reverting now to the gasket 12, and as can further be seen in FIG. 2A, the gasket is substantially cylindrical and is formed with an annular rim 20 giving rise to an annular shoulder 22 constituting a seating at 26 for sealingly receiving the mold shell 14. In this particular embodiment, mold shell 14 is retained in its position owing to elastic forces of the gasket, made of resilient material.

It is appreciated that sealing between the mold shell and the gasket may be carried out against either or both the shoulder 22 (‘face sealing’) and the peripheral portion 27 (‘radial sealing’) of the gasket.

Integrally formed with the gasket 12, there is a membrane 30 formed with an inside face 32 having a negative image of a second face of a lens to be manufactured by the gasket 10 molded in the cavity 36 extending between the membrane 30 and the mold shell 14, the latter retained at a preset distance from the membrane 30 thereby giving rise to a cavity 36 of predetermined shape.

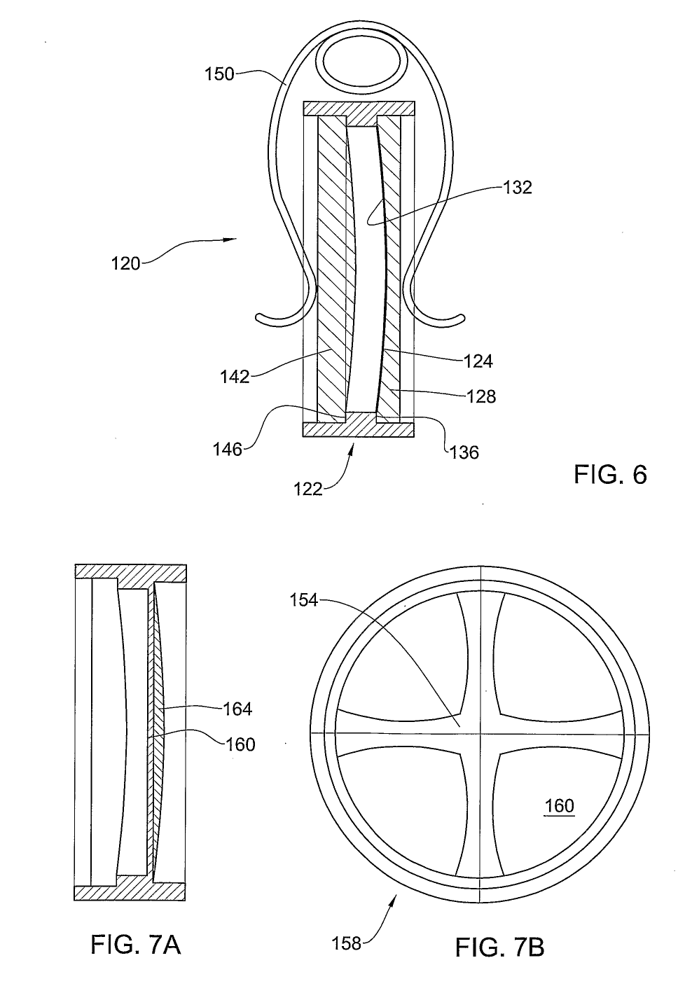

In the embodiment of FIGS. 1 and 2, the membrane 30 is substantially flat and smooth though, as will be appreciated hereinafter, it may assume different shapes. Furthermore, the membrane 30 may be sufficiently rigid or may be elastically deformable, as will be explained hereinafter in connection with the embodiment of FIG. 6.

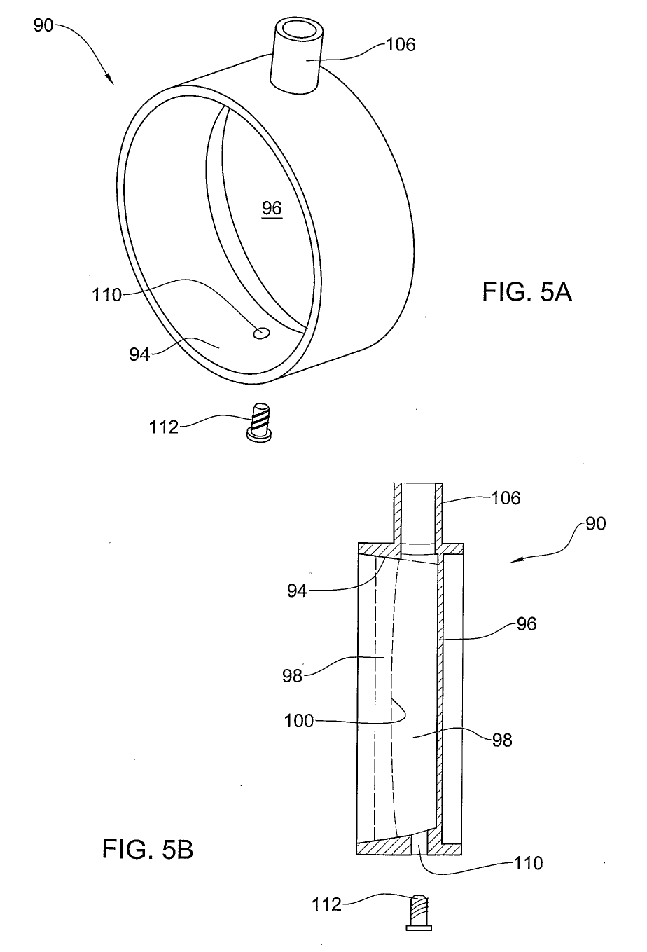

In accordance with the particular embodiment of FIGS. 1 to 4 and FIGS. 6 and 7, the liquid molding material is introduced into the molding cavity when the mold is laying with an axis thereof extending substantially vertically whilst in accordance with FIGS. 5A and 5B the lenses are molded with the gasket extending upright via an inlet port fitted at a top portion of the gasket, as will be explained hereinafter in further detail.

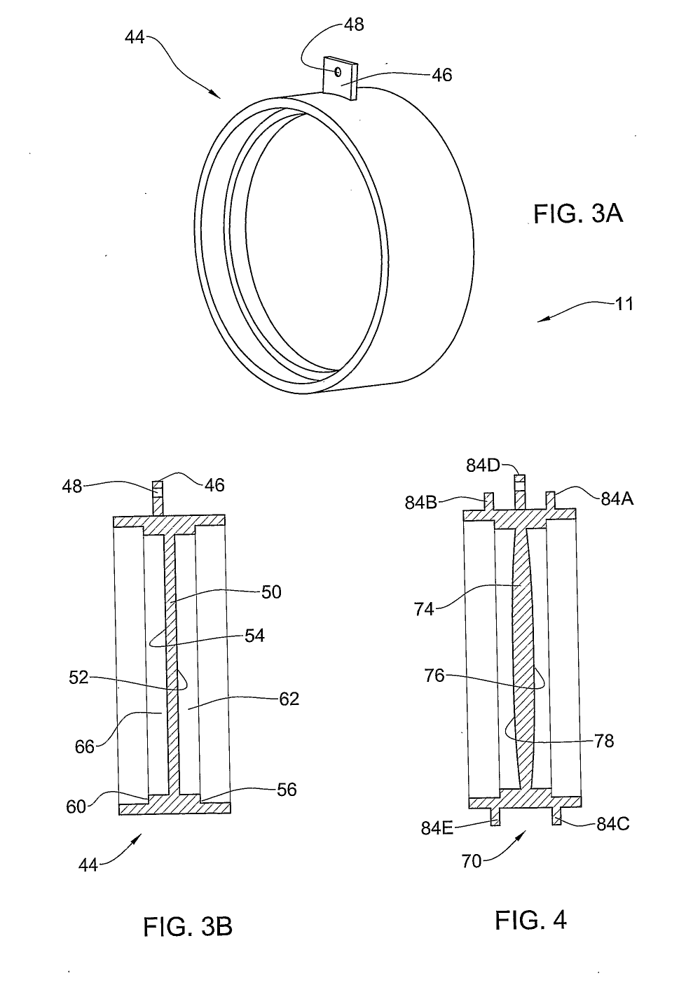

Turning now to FIG. 3A, there is illustrated a gasket generally designated 44, being substantially similar to the gasket 12 of FIGS. 1 and 2, however with the exception that it comprises a tab 46 used both for stripping the gasket from the mold shell (not seen) and for retaining the gasket 44 at an upright position, e.g. during the curing process. For that purpose, tab 46 is fitted with an aperture 48 by which the gasket may be hung. It is appreciated that the gasket may be fitted with one or more such tabs.

Furthermore, and as can be seen in more detail in FIG. 3B, gasket 44 is a double mold, i.e. adapted for simultaneously molding to semi-finished lenses. Gasket 44 is fitted with a substantially flat membrane 50 having a first face 52 and a second face 54 and a first annular shoulder 56 serving as a first mold shell seating, and a second annular shoulder 60 serving as a seating for sealingly supporting a second mold shell (not shown) such that at an assembled position of a lenses mold comprising a gasket in accordance with FIG. 3B, there is first molding cavity 62 and a second molding cavity 66 corresponding with the first face 52 and a second face 54, respectively, of membrane 50.

FIG. 4 illustrates a gasket 70 which is a modification of the gasket seen in FIG. 3 wherein the membrane 74 has a first face 76 and a second face 78, both being concave surfaces such that a lens blank molded in a mold making use of a gasket in accordance with this embodiment has both faces thereof finished (i.e. final surfacing as far as corrective power and surface quality) and it now remains only to machine the contour of the lens to fit to a particular spectacles frame.

It is further noted that gasket 70 is formed with several tabs 84A through 84E where tab 84D serves as a hanging tab, whilst the other tabs serve as stripping aid tabs. Furthermore, it may be appreciated that rather than lateral projecting tabs, these portions may be annular or segmented ribs for rigidifying the structure of the gasket.

Other features of the gasket 70 are substantially similar to those disclosed in connection with the embodiment of FIGS. 3A and 3B.

Turning now to the embodiment illustrated in FIGS. 5A and 5B, there is illustrated a lens molding gasket in accordance with still an embodiment of the present invention generally designated 90 wherein the mold shell is adapted to be sealingly supported over an inwardly tapering surface 94 gradually extending towards the membrane 96. In accordance with this embodiment, positioning of a rigid molding shell 98 (illustrated by dashed lines in FIG. 5B) to thereby give rise to a molding cavity 98 extending between membrane 96 and an inside surface 100 of the mold shell 98.

As can further be noticed in the embodiment of FIGS. 5A and 5B, there is a filling tube 106 formed with a filling port extending into cavity 98 through which liquid molding substance is introduced. Furthermore, there is an airing port 110 sealable by a plug member 112 whereby during introducing the molding liquid into the cavity, air is allowed to escape therefrom and thereafter the airing port 110 is sealed during the curing process. It is appreciated that in some instances the sealing port and the airing port may extend at other positions, e.g. in reverse location, namely the liquid molding substance may be introduced into the cavity through a port extending at a bottom position of the gasket (when the gasket is in a vertical position, and the airing port may be at an uppermost location thereof).

Turning now to FIG. 6, there is illustrated a lens mold generally designated 120 comprising a molding gasket in accordance with an embodiment of the present invention generally designated 122 comprising an integral membrane wall 124 similar to the embodiment of FIGS. 1 and 2, though made thinner and substantially flat and smooth. Thus, it may be required to support the membrane 124 with an external supporting member 128, e.g. a disc made of rigid material such as glass or plastic material wherein an inside face thereof 132 may assume a concave shape such that when the support member 128 is positioned in place, i.e. bearing against annular shoulder 136, the membrane 124 follows the inside surface 132 of the support member 128 and assumes a corresponding concave shape as well.

As can further be seen in FIG. 6, a mold shell 142 is assembled to the gasket 122 in the same manner as explained in connection with FIG. 2B, i.e. such that it annularly bears in a sealing member against an annular shoulder 146. In this example, the mold shell 142 and the supporting member 128 are clampingly retained by means of a clamping spring 150 serving also to hang the mold and retain it at an upright position.

Whilst in the embodiment of FIG. 6, the membrane 124 is supported by a removable support member 128, the embodiment of FIGS. 7A and 7B illustrate a lens molding gasket 158 wherein the membrane 160 bears against a ribbed support structure 164 (which in the present example is a four-armed support member, though any other configuration is suitable for that purpose), it is further appreciated that the support member may be fixedly attached or removable from the gasket 158 and may assume different sectioned shapes so as to impart the membrane 160 with different corresponding configurations, as discussed hereinabove.

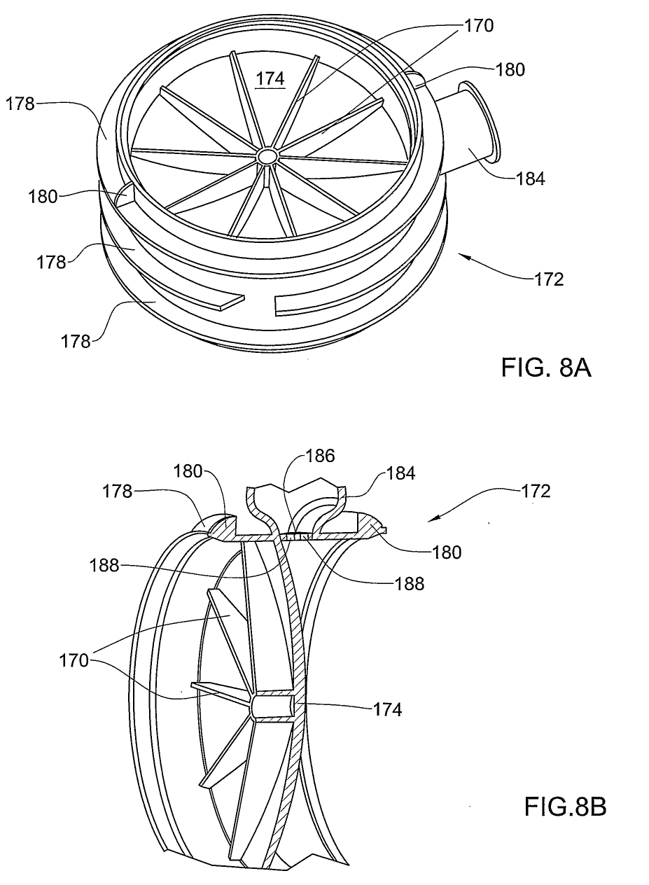

As mentioned above, the support structure may also be in the form of a plurality of support ribs 170 (FIGS. 8A and 8B) integrally formed with the gasket 172 and the membrane 174 is deformed owing to said rigidifying ribs 170. A clamping spring such as spring 150 in FIG. 6 may bear against said support structure 164 (FIGS. 7A and 7B) or said support ribs 170 (FIGS. 8A and 8B).

Also seen in FIGS. 8A and 8B, the gasket 172 is reinforced by several peripheral ribs 178 and several radial ribs 180. Furthermore, gasket 172 comprises a spout 184, comprising a main port 186, typically for filling, and two subsidiary ports 188, typically for draining air during filling.

It is further appreciated that during the molding process the mold shell may be retained in position within the gasket by a pressure mechanism, which may also be used for imparting the membrane with its shape.

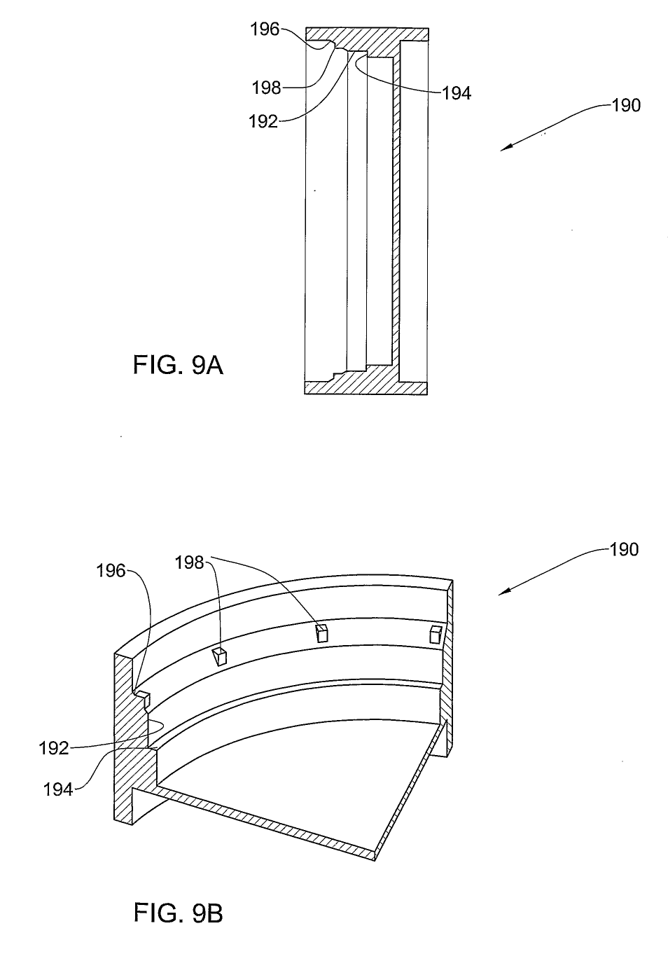

Further attention is now directed to FIGS. 9a and 9b of the drawings, illustrating still another embodiment of a lance molding gasket generally designated 190 which principally has the same shape as of the gasket 12 of FIGS. 1 and 2, however with the exception that the peripheral portion 192 (the peripheral portion adapted for sealing engagement about the—not shown) between an annular shoulder 194 (constituting a seating for sealingly receiving a mold shell, as explained hereinabove) and between an inclined portion 196 serving for loosely receiving the mold shell, which portion 196 has a diameter slightly larger than that of the intended mold shell.

Formed on the inclined portion 196 there is a plurality of radialy projecting mold shell support members 198 serving as seats such that when the gasket 190 is in its horizontal position a lance mold may be loosely placed over the projections 198 and centered thereover, such that by merely applying axial pressure over the lance mold it can be sealingly displaced into its position within the peripheral sealing portion 192 bearing against the annular shoulder 194.

It is to be appreciated that instead of radial projections 198 there may be formed an annular rim or other forms of projections which in our applying some force yields under the mold shell and allow for axial displacement thereof into its position.

Whilst several embodiments have been shown and described, it is to be understood that it is not intended thereby to limit the disclosure of the invention, but rather it is intended to cover all modifications, embodiments and arrangements falling within the spirit and the scope of the invention, mutatis mutandis.

1. A lens molding gasket comprising one integral membrane serving as a mold shell, said integral membrane having an inside face having a negative image of a face of a lens to be molded by said gasket. and a seating for a removable mold shell.

2. A lens molding gasket according to claim 1, wherein the gasket comprises a seating for supporting a rigid mold shell having a negative image of a first face of the lens, and a membrane integral with the gasket for forming a second face of the lens, such that said mold shell is retained at an axially spaced apart relation from said membrane, giving rise to a cavity extending therebetween.

3. A lens molding gasket according to claim 2, wherein a support surface axially extends from the membrane serving to sealingly support the rigid mold shell at a fixed axially spaced apart relation from the membrane.

4. A lens molding gasket according to claim 3, wherein the support surface is in form of a radial inwardly projecting rim.

5. A lens molding gasket according to claim 3, wherein the support surface is a smooth and flat inside surface of the gasket wherein the rigid mold shell is held in position owing to pressure applied by the gasket.

6. A lens molding gasket according to claim 3, wherein the support surface is a smooth inside surface of the gasket, tapered inwardly, wherein the rigid mold shell is held in position owing to pressure applied by the gasket.

7. A lens molding gasket according to claim 2, wherein the membrane is reinforced to retain its shape.

8. A lens molding gasket according to claim 7, wherein the membrane is reinforced by thickened support portions integral therewith.

9. A lens molding gasket according to claim 7, wherein the membrane is reinforced by a support member fixable behind the membrane.

10. A lens molding gasket according to claim 7, wherein the membrane is reinforced by a plurality of support integral support ribs.

11. A lens molding gasket according to claim 2, wherein the membrane is flat or pre-shaped to be concave/convex.

12. A lens molding gasket according to claim 2, wherein the gasket is formed as single mold for molding a single blank at time.

13. A lens molding gasket according to claim 2, wherein the gasket is formed as double mold for simultaneously producing two molds, oriented back-to-back or otherwise.

14. A lens molding gasket according to claim 13, wherein, the membrane serves as a molding face common for both lenses.

15. A lens molding gasket according to claim 2, further comprising one or more ports extending from the cavity, said one or more ports serving as filling and/or airing ports.

16. A lens molding gasket according to claim 2, wherein the membrane has a negative image of the rear faces of the semi- finished lens.

17. A lens molding gasket according to claim 1, wherein the membrane is substantially flat and elastically deformable into a required shape by a forming member imparting the membrane said required shape.

18. A lens molding gasket according to claim 17, wherein the forming member is a supporting backing removably attachable behind the membrane.

19. A lens molding gasket according to claim 17, wherein the forming member is a supporting pouch containing liquid or gas for bearing against the diaphragm.

20. A lens molding gasket according to claim 1, being disposable or recyclable for more then one use.

21. A lens molding gasket according to claim 1, made of resilient material.

22. A lens molding gasket according to claim 2, wherein the mold shell is retained by a retention spring member.

23. A mold for molding a semi-finished-lens comprising:
a first face and a second face, the mold comprising a gasket formed with a seating for supporting a rigid mold shell having a negative image of said first face of the lens, and
a membrane integral with the gasket for forming the second face of the lens, with a cavity formed between said mold shell and said membrane.

24. A lens molding gasket according to claim 1, wherein a mold shell support is provided for loosely retaining the mold shell over the gasket at a position prior to its insertion into its final position to create a molding cavity

25. A lens molding gasket according to claim 24, wherein the mold shell support comprises a plurality of projections or a circumferential continues rib from at or adjacent an edge of the gasket, the inside diameter of said projections being slightly less then that of the mold shell.

26. A lens molding gasket according to claim 2, wherein said the shape and size of said cavity determines shape and size of a lens to be molded by said gasket.

27. A method for molding a semi-finished lens, the method comprising:
providing a lens molding gasket having an integral membrane serving as a mold shell, said integral membrane having an inside face having a negative image of a face of said semi-finished lens;
positioning a removable mold shell in a seating in said gasket for sealingly receiving said removable mold shell; and
introducing molding material into a molding cavity between said integral membrane and said removable mold shell.

28. A method according to claim 27, wherein said introducing comprising pouring said molding material through at least one filling port extending from said molding cavity.

29. A method according to claim 27, further comprising, while introducing molding material, allowing air to escape from said cavity through at least one airing port extending from said molding cavity.

30. A method according to claim 27, further comprising attaching a forming member to said integral membrane in order to impart a required shape to said integral membrane.

31. A method according to claim 27, further comprising retaining said removable mold shell at a distance from said integral membrane according to a required shape of said cavity.

32. A method according to claim 31, wherein said retaining is by pressure applied by said gasket on said removable mold shell.

33. A method according to claim 31, wherein said retaining is by pressure applied by a support surface axially extends from the membrane serving to sealingly support the rigid mold shell at a fixed axially spaced apart relation from the membrane.

34. A method according to claim 31, wherein said retaining is by pressure applied by a radial inwardly projecting rim.

35. A method according to claim 31, wherein said retaining is by pressure applied by an smooth and flat inside surface of the gasket.

36. A method according to claim 31, wherein said retaining is by pressure applied by an inside surface of the gasket, tapered inwardly.

37. A method according to claim 31, wherein said retaining is by a retention spring member.

38. A method according to claim 27, further comprising reinforcing said integral membrane by a support member.

39. A method according to claim 27, wherein said positioning is for creating a molding cavity, shape and size of said cavity determines shape and size of a lens to be molded by said gasket.

40. A semi-finished lens produced by the method of claim 27.
